(19) United States
(12) Patent Application Publication
(10) Pub. No.: US 2006/0257709 A1
(43) Pub. Date: Nov. 16, 2006

(54) Modularly built high-temperature fuel cell system

(76) Inventors: Ludger Blum, Julich (DE); Roland Peters, Linnich (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/547,711

(22) PCT Filed: Feb. 10, 2004
(86) PCT No.: PCT/DE04/00229

§ 371 Date: Aug. 30, 2005

(30) Foreign Application Priority Data
Mar. 12, 2003 (DE) 10310642.1

(51) Int. Cl. H01M 8/04; H01M 8/06

(52) U.S. Cl. 429/38; 429/26; 429/20; 429/13

(57) ABSTRACT

Until now, additional components such as afterburners, reformers or heat exchangers are arranged as separate units and, as a rule, are connected to the high-temperature fuel cell stack by means of pipes. The disadvantage of this construction method is that it requires a large constructional volume and high investment costs to install said components. The invention relates to a high-temperature fuel cell system that is modularly built, wherein the additional components are advantageously and directly arranged in the high-temperature fuel cell stack. The geometry of the components is matched to the stack. Additional pipeworking is thereby no longer necessary, the style of construction method is very compact and the direct connection of the components to the stack additionally leads to more efficient use of heat.

The invention relates to a high temperature fuel-cell system comprising a high temperature fuel cell stack as well as additional components used in conjunction therewith, especially an after burner, a reformer, and a heat exchanger, whereby each of these components respectively show a very compact mode of construction.

### STATE OF THE ART

High temperature fuel cell stacks are as a rule assembled from individual fuel cells stacked one upon another. For optimal feed and discharge of the fuel gas in common for the fuel cells and for the oxidizing gas, very compact configurations are possible.

In a high temperature fuel cell as a rule only a part of the fuel gas is converted electrochemically in the cell. The unreacted fuel gas (about 10 to 30%) is usually subjected to after burning with the hot exhaust air from the cathode compartment. For that purpose a separate apparatus is known from the literature in which the nonreacted anode waste gas is reacted with air and is thus afterburned. This on the one hand prevents the release of the unreacted fuel gas into the atmosphere. On the other hand the afterburning produces usable energy from the residual fuel gas which can be employed completely for heating purposes or used in other components downstream of the fuel cell, for example a gas turbine.

The volume required for such a separate afterburner, depending upon its structural type, can be disadvantageously very large and requires when the afterburner is built into a high temperature fuel cell system, significant costs for piping and installation.

It is also known that in the high temperature fuel cell the air or the oxidizing gas for the cathode side of the stack must be preheated. For this purpose, as a rule the oxidizing gas is preheated in a recuperator with the heat from the hot exhaust gas of a high temperature fuel cell stack or from an afterburner. For this heat exchange, tube-bundle heat exchangers or plate-type heat exchangers in a welded configuration are suitable and conventionally are provided commercially from alloys which are highly heat resistant or refractory. The incorporation of such separate devices in a high temperature fuel cell system is associated with disadvantageously high piping cost and installation cost.

In addition, with high temperature fuel cells it is also known that in operation with natural gas at least a part of the gas and especially the higher hydrocarbons in the natural gas must be reformed before the gas enters the fuel cell or the anode chamber.

To carry out a reforming, a tubular reactor with a packing of catalyst pellets is known from the literature. It is also known to incorporate such pellets even in plate heat exchangers so as to produce defined flow conditions and better heat transfer. Such reformers are similar to the afterburners known from the state of the art in their disadvantage that they occupy large volumes, depending upon the type of construction and lead to significant piping and insulation costs.

### OBJECT AND SOLUTION

The object of the invention is to provide a compact high temperature fuel cell system with a fuel cell stack and at least one additional component and such that advantageously the additional component is modular and can be integrated in a very compact way in the fuel cell system.

### SCOPE OF THE INVENTION

In the framework of the invention it has been found that it is advantageous for the structure and operation of a high temperature fuel cell system to provide additional components which have heretofore been mounted separately, like for example an afterburner, a reformer or also a heat exchanger, directly on a high temperature fuel cell stack. The connection of these components is effected directly or through suitable intermediate connectors, especially in the form of intermediate plates. The geometry of the components and the intermediate or terminal plates, especially their outer dimensions are matched suitably to the geometry of the fuel cell stack.

Advantageously, in this manner at least one additional component can be coupled to the high temperature fuel cell stack, especially, however, a combination of a number of components, like for example an afterburner, preheater and prereformer. Since all of these components are advantageously themselves compact and can have a construction matched to the high temperature fuel cell, it is possible for the overall high temperature fuel cell system according to the invention to have a uniformly especially compact and thus highly advantageous construction. The piping or casing costs for the individual components drop practically to zero and the heat losses are significantly reduced. The high temperature fuel cell system according to the invention is thus of lower cost and also significantly more effective than known arrangements in accordance with the state of the art.

The feed and discharge passages for the operating agents or media and/or the exhaust gases of the additional components are directly matched to the high temperature fuel cell stack so that the component can be arranged in direct contact with the high temperature fuel cell stack. On the side turned away from the high temperature fuel cell stack the additional component can have corresponding connecting fittings for the passages for the operating media and/or waste gases or further piping within the fuel cell system.

An alternative embodiment of the invention provides that the additional component be connected to the high temperature fuel cell stack by an intermediate plate. The intermediate plate therefore assumes advantageously the function of bridging between or interconnecting the flow passages of the high temperature fuel cell stack and the component.

In addition, a further embodiment of the invention provides that the connection of the passages for the operating agents and/or the waste gas of the component is effected via a terminal plate for further piping or casing within the fuel cell system.

By a clever combination of the individual components, in addition, an increase in efficiency is enabled. An especially advantageous configuration of the invention is provided for a high temperature fuel cell stack where the individual components are coupled thereto by an intermediate plate and include at least one afterburner. With the additional coupling, for example of an air preheater and/or a preformer to the high temperature fuel cell stack, the heat transfer is optimally used in a consequent manner.

Furthermore, an economical fabrication of these components is possible by comparison to the state of the art, since the outer dimensions of the components and the locations for the feed throughs for operating media and gases can be the same for all components or at least provided in a highly similar manner which increases the number of identical components.

Special Description Part

Below the subject matter of the invention is described in greater detail with figures and special embodiments without thereby limiting the scope of the invention.

### THE DRAWING FIGURES SHOW

FIG. 1: a schematic illustration of a high temperature fuel cell stack with an additional component which is joined at the one side via an intermediate plate to the high temperature fuel cell stack and on its other side has a terminal plate.

FIG. 2a: a schematic illustration of an additional component and functioning as an afterburner.

FIG. 2b: a schematic illustration of an additional component with the function of an afterburner with porous material.

FIG. 3a a schematic illustration of an additional component with the function of a heated prereformer.

FIG. 3b a schematic illustration of an additional component with the function of a heated prereformer.

FIG. 3c a schematic illustration of an additional component with the function of an unheated prereformer.

FIG. 4a, 4b, 4c, 4d schematic illustrations of a high temperature fuel cell system according to the invention with a high temperature fuel cell stack and a connection of three additional components which are directly joined to the fuel cell stack and in which in the FIGS. a, b, c and d different additional goods within the fuel cell system are shown.

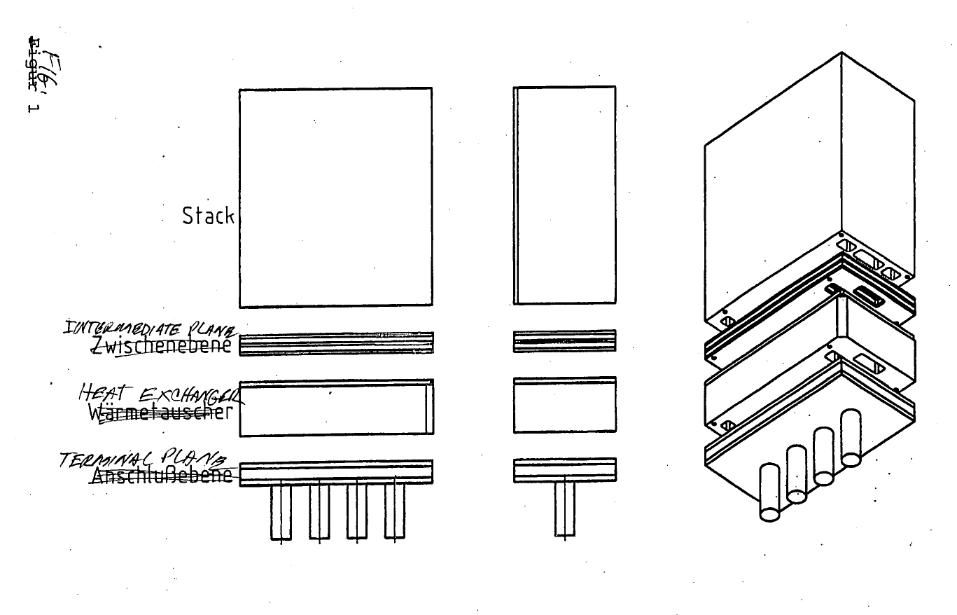

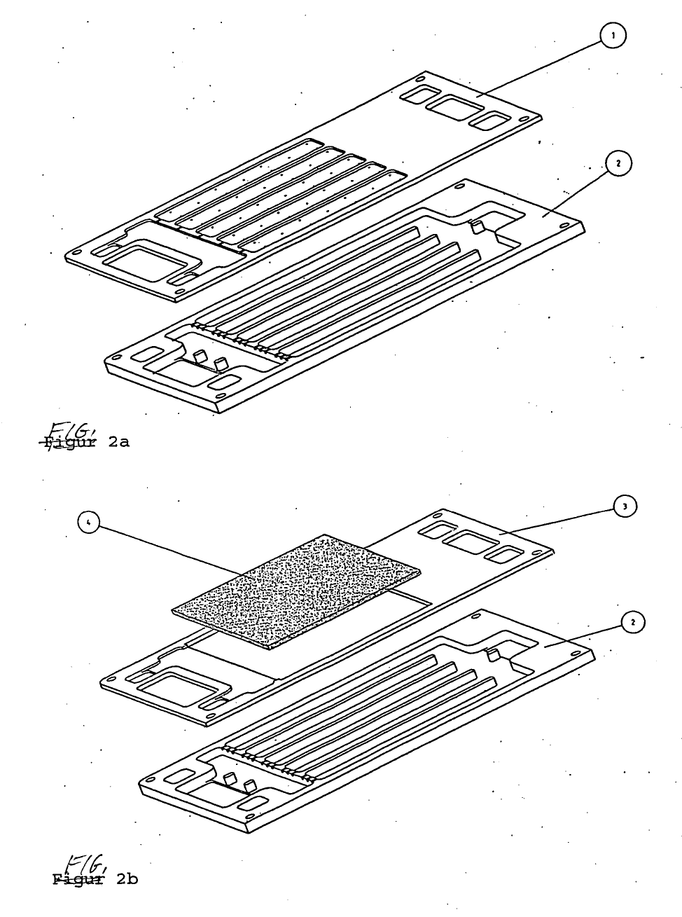

### FIRST EMBODIMENT: AFTERBURNER AS ADDITIONAL COMPONENT DIRECTLY CONNECTED TO THE HIGH TEMPERATURE FUEL CELL STACK

The compact configuration of an afterburner according to the invention allows it to be directly coupled to the stack without additional piping and insulation. As a result there is a very compact configuration with reduced surface area (minimum heat loss, minimum volume and weight and thus reduced costs) and simple coupling to the stack. Waste gas and waste air are brought together in a kind of porous plate-shaped structure in which they can burn in a controlled manner. The combustion chamber is controlled by the air excess (possibly also by the metering of cold fresh air to the combustion) normally the combustion develops spontaneously (that is without an additional ignition source) since the temperature of the mixture at the outlet of the high temperature fuel stack lies above the ignition temperature of the participating fuel gases (above all H₂, CO, CH₄) for the case in which the temperature is too low (heat loss), further reduced operating temperature of the high temperature fuel cell, the surface area in the combustion chamber can be coated with a noble metal, preferably platinum.

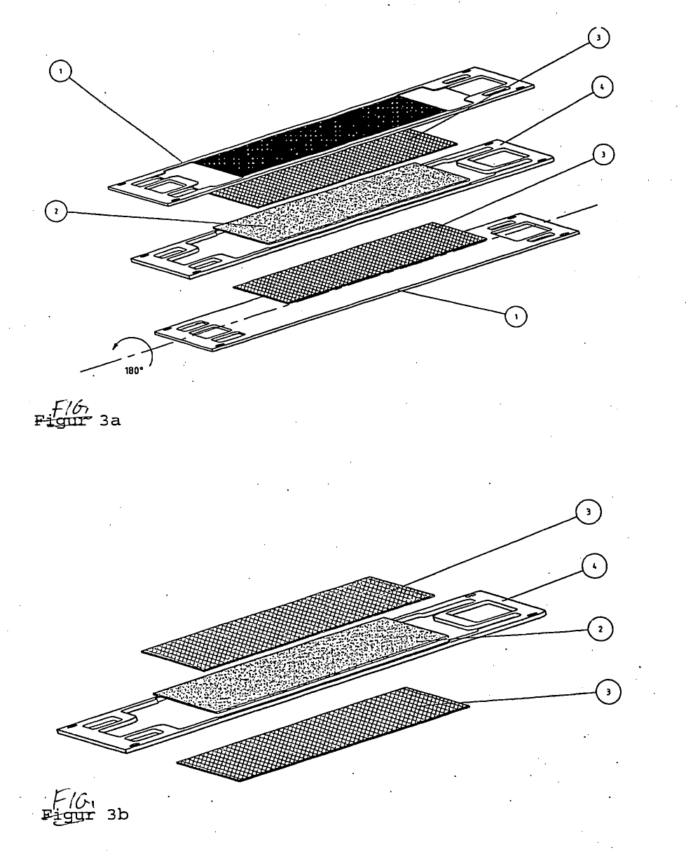

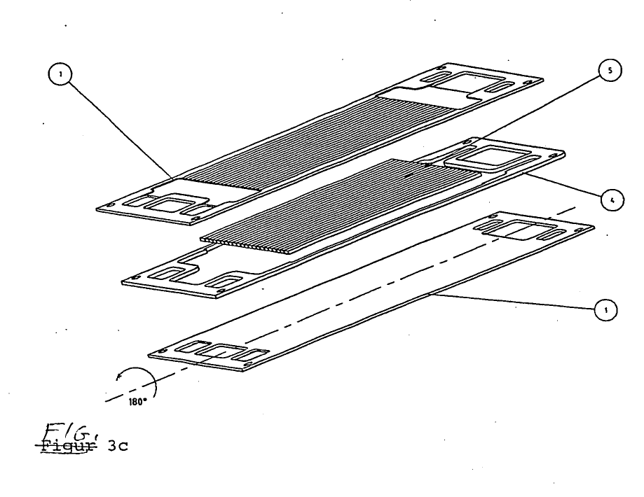

FIGS. 2a and 2b show an additional component for a high temperature fuel cell stack with the function of an afterburner.

The afterburner has a plate shaped configuration. In that configuration the exhaust gas plane and the exhaust air plane alternate with one another.

In FIG. 2a, the exhaust gas plane 1 is comprised of a metal plate into which the gas distributor and flow passages have been worked. The anode waste gas from the stack is supplied to the gas distributor compartment which is designed for uniform flow distribution into milled out channels. The exhaust gas is uniformly distributed in these channels. They are provided in addition with a large number of small bores or holes through which the anode exhaust gas is fed to the waste air plate lying therebelow. Depending upon the bore diameter and the number of holes the discharge gas volume can be adjusted.

The waste air plate 2 is of similar construction to the waste gas plate. The waste air here emerges from the stack also through a distributor compartment into the waste air passages. The gas flowing out of the bores of the waste gas plate is introduced from above into the waste air. Because of the high temperature of the two media, at the location at which they flow together a spontaneous combustion develops of the combustible component contained in the anode waste gas. By a variation in the passage depths in the waste gas plate, the residence time of the gas in the afterburner can be matched to that which will ensure a complete combustion of all components.

In the case of a reduced operating temperature in the stack, the surface area in the flow passages of the waste air plate can be provided with a noble metal coating. In this manner a catalytic conversion at a lower temperature can be carried out.

The waste gas plate and the waste air plate form an afterburner unit. The entire afterburner can have a variable number of such units. Because of this modular construction the afterburner can be matched to the particular stack power class. The two plates, between themselves and between the interconnected afterburner units, are so joined together that the escape of gas outwardly is excluded.

The embodiment of the afterburner which has been shown in FIG. 2b has a similar construction to the afterburner of FIG. 2a. The waste air plate 2 is unaltered. As for the waste gas plate 3, the flow passages and bores are replaced by a porous material 4 (porous ceramic, sintered or foamed metal). This material assumes the task of flow distribution of the gas in the place and the uniform admission of the exhaust gas into the waste air plane. By the selection of suitable material in terms of pore size, pore distribution, the pressure loss and the waste quantity which is supplied the waste air can be adjusted. The porous material 4 can be provided at the contact locations with the waste gas plate and bonded thereto by a bonding process (for example soddering, welding, etc.). As a result of this feature, an uncontrolled flow of the waste gas into the waste air stream can be avoided.

In addition the surfaces can be provided here with a catalytically active material. A matching by the charge of the number of units as described above to the stack power class is possible.

### Second Embodiment: Prereformer as Additional Component Directly Connected to the High Temperature Fuel Cell Stack

The compact construction of a prereformer according to the invention allows it to be mounted directly on the afterburner on the stack without additional piping or casing structures and insulation. As a result, a highly compact configuration is obtained with a reduced surface area (low heat loss, low volume and weight and thus low cost) and simpler connection to the stack. This allows a simplified heating of the endothermic reformation reaction through the plate heat exchange structure through which the hot exhaust gas of the stack can be passed.

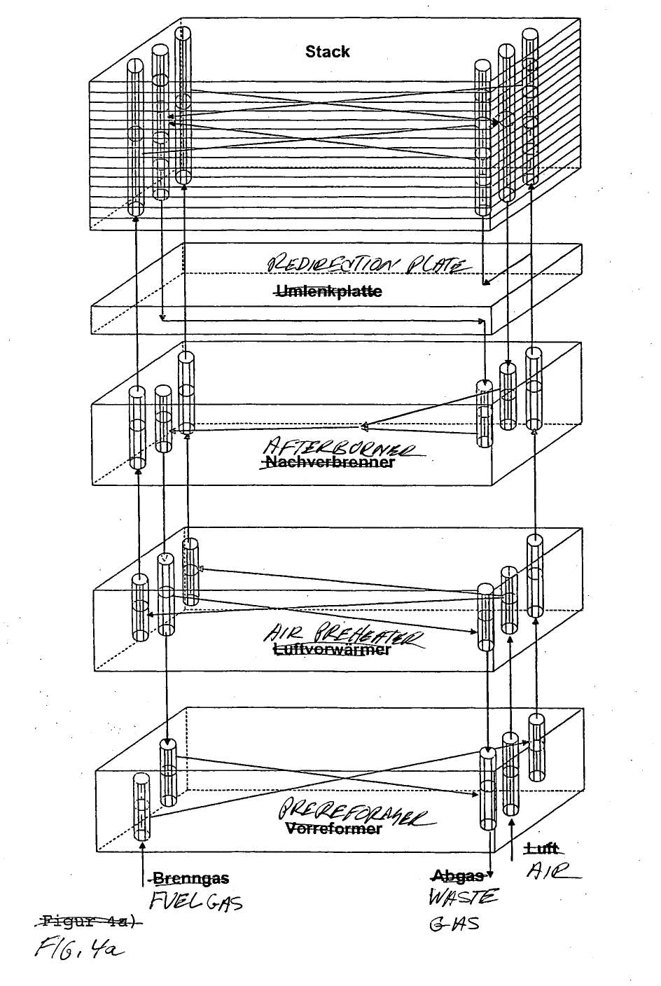

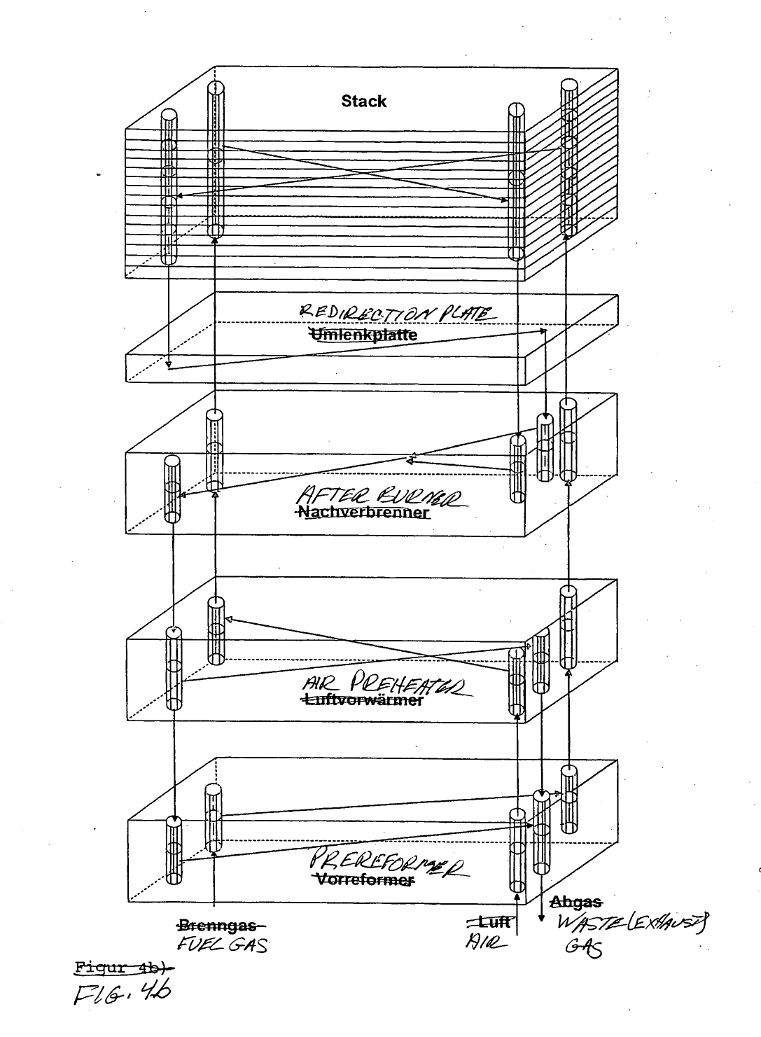

In order to realize this design, an efficient plate shaped catalyst is required. The anode substrate of the SOFC cell fulfills, apart from the requirements with respect to electrochemical activity and mechanical stability, also that of a reformation catalyst. This substrate is incorporated as a catalyst in the plate shaped reformer. FIG. 3a shows a heated reformer as the additional component. In this case, a fuel gas plane and a waste gas plane alternate with one another. The separation of the two gas spaces is achieved by each of the reformer plates 1 respectively, whereby the reformer plate 1 is rotated, as the occasion requires, by 180° about its longitudinal axis with respect to the adjacent reformer plate. These metal plates serve to guide the waste gas stream through the reformer. For this reason on one side of the place gas distributor and collector structures as well as a multiplicity of flow passages are formed in the plate.

The fuel gas mixture must be supplied to the catalyst material of which the anode substrate 2 of the high temperature fuel cell is formed. To fix this anode substrate in the reformer structure a metal frame 4 is provided in which the catalyst material is received. To ensure that the fuel gas mixture will come into contact with the catalyst material, on the upper and lower sides of the anode substrate, respective wire meshes 3 are inserted. Because of the point like contact of the wire mesh a sufficiently large reaction surface between the catalyzer material and the fuel gas is ensured. This wire mesh serves at the same time the function of forming flow passages for the fuel gases.

Alternatively, distributor structures and flow passages can be machined into the second side of the reformer plate. The metal frame, the wire mesh fabrics and the anode substrate form the fuel gas side of the reformer.

Two reformer plates with a channel or passage structures form respectively the terminal or closure of the exhaust gas side of the reformer. These five components form a reformer unit. The entire reformer is produced from a variable number of such units. Because of this modular construction, the reformer can be matched to the stack power class. The reformer frame and the reformer units can be so soldered together that they exclude a release of the gas toward the exterior or a mixing of the gas streams within the reformer.

FIG. 3b shows an unheated reformer as an additional component. The reformer is comprised of a plate like structure comparable with sketch I. However, the places for the waste gas side or omitted since the reformer is driven adiabatically. This simplifies the construction of the reformer and has been found to be especially suitable for operation with a sufficiently preheated fuel gas and a moderated reforming rate.

In FIG. 3c, the flow paths in the catalyzer plate have been shown. The reformer comprises a plate shaped configuration, comparable with that of FIG. 3a or FIG. 3b. However, the flow paths and the net meshes used for distribution are replaced by grooves or passages which are machined into the catalyst material. This can be done already at the catalyst fabrication process or by a subsequent mechanical machining. As a result the number of components can be further reduced and simultaneously the surface area in contact with the gas to be reformed can be increased whereby the efficiency is enhanced further.

### Third Embodiment: A Combination of Afterburner, Heat Exchanger and Prereformer as Additional Components which are Directly Coupled with the High Temperature Fuel Cell Stack

An especially advantageous embodiment of the invention provides that not only one component but rather a plurality and especially three components are directly coupled onto a high temperature fuel cell stack. In this manner, the advantages of the compact construction are increased still further. The direct coupling saves installation cost and saves piping. The short paths of the gas and drive medium between the components and the stack give rise advantageously to an effective heat transfer and thus increase the efficiency of the entire system.

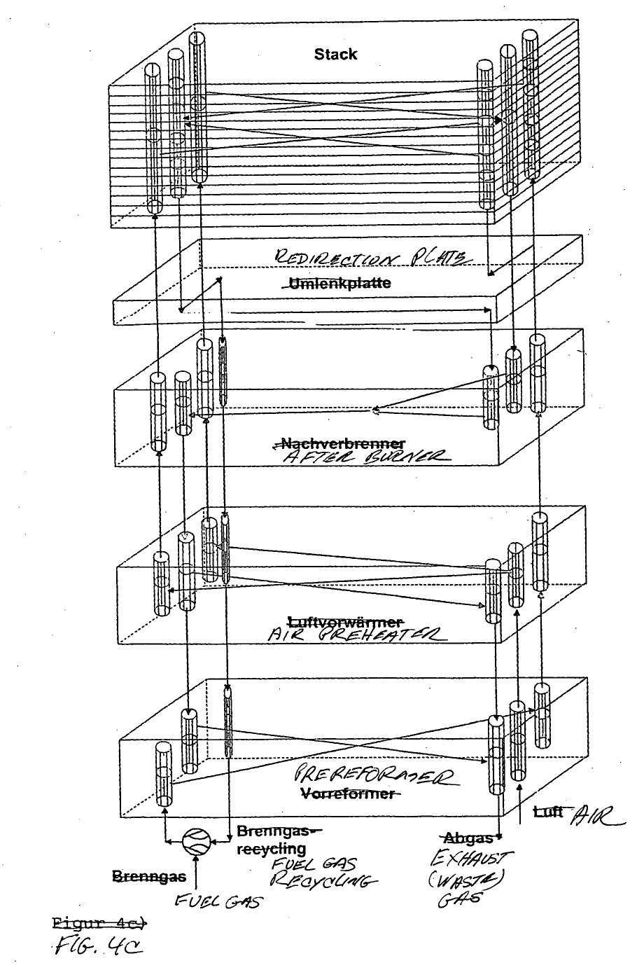

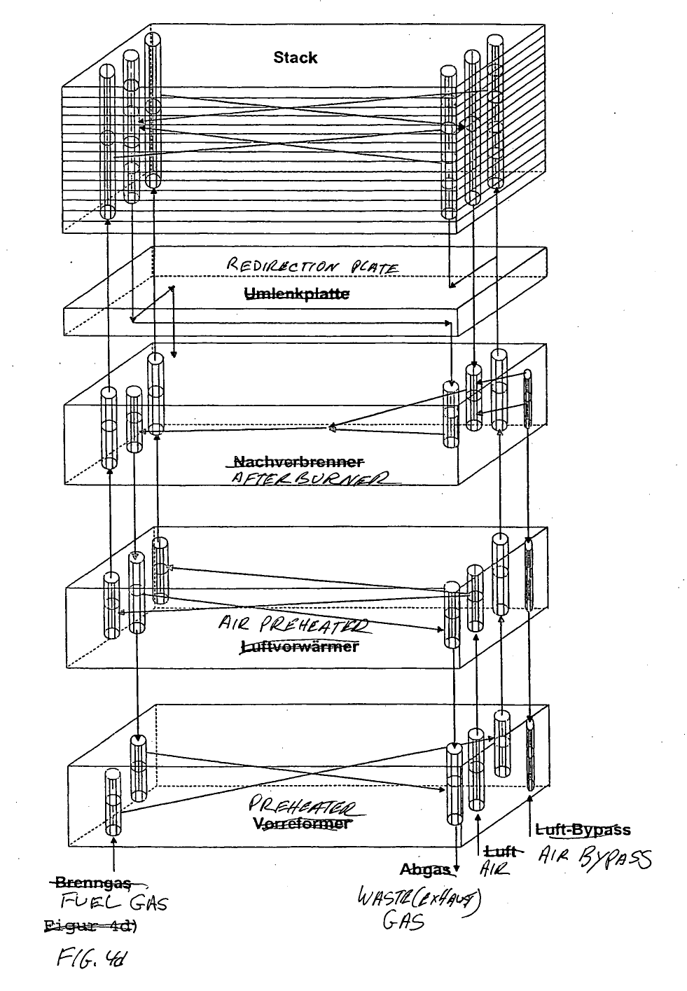

The FIG. 4 show an especially advantageous embodiment of the modular system. An afterburner adjoins a high temperature fuel cell stack through a flow redirecting plate connector. To the afterburner a heat exchanger and a reformer are directly connected. The channels (bores) for the individual gases and operating medium [fuel] are located in similar positions for all of the additional components so that advantageously no additional redirection plates are required between the individual components themselves. The coupling of the individual components between one another and also the first of the components to the stack is effected for example directly via a face to face bonding or flush bonding by means of glass solder or metal solder.

The individual gas flows have been indicated in FIGS. 4a through 4d for various short path traversals of the individual components.

FIG. 4a: The afterburner, air preheater and prereformer are connected to the underside of the stack by a redirection plate in which the fuel gas is redirected at two locations. The gas feed is matched to the gas feed in the stack in which the fuel gas and air each flow in through two passages and out through one passage.

FIG. 4b: The afterburner, air preheater and prereformer are connected by a restriction plate to the underside of the stack. The fuel gas is redirected in one location at the restriction plate.

The gas feed is matched to a simplified gas feed or the stack in which fuel gas and air each flow in through one passage and flow out through one passage.

FIG. 4c: The afterburner, air preheater and prereformer are connected to the underside of the stack by a restriction plate in which the fuel gas is redirected. To increase the fuel gas utilization in the system in a simple manner it is desirable for a part of the fuel gas which emerges unused from the stack to be mixed again with the fresh fuel gas. This fuel gas recycling can be realized in a simple manner without expensive piping. When a branch passage is provided in the redirection plate, through the branch passage and additional bores in the remaining components, a part of the exhaust gas is fed to the bottom plate where through short piping for example via a jet pump, it can be mixed with the fresh fuel gas.

FIG. 4d: The afterburner, air preheater and prereformer are connected by a restriction plate in which the fuel gas is redirected, to the underside of the stack. It is required to reduce the temperature in the afterburner it is possible to admix cod fresh air with the hot exhaust gas. This mixing can be achieved in a simple way without expensive piping when an additional bore is provided through which the additional air can be added to the waste air at the entrance to the afterburner.

1. A high temperature fuel cell system with a planar high temperature fuel cell stack and at least one component, characterized in that the component is arranged directly on the side of the high temperature fuel cell stack on which the drive medium feed and discharge lines are arranged.

2. The high temperature fuel cell system according to claim 1 in which the outer geometries of the component and the high temperature fuel cell stack are matched to one another, especially to have identical dimensions with respect to the surfaces which abut one another.

3. The high temperature fuel cell system according to claim 1 wherein the component has a separate connecting plate which joins the component to the high temperature fuel cell stack and which enable a direct feed of gases from the fuel cell into the component and vice versa.

4. The high temperature fuel cell system according to claim 1 in which on the side of the component turned away from the fuel cell stack a terminal plate is arranged which has a geometry matching that of the high temperature fuel cell stack or the first component.

5. The high temperature fuel cell system according to claim 1 in which at least one further component is coupled directly onto the first component and has a geometry which matches that of the high temperature fuel cell stack or the firs component.

6. The high temperature fuel cell system according to claim 1 with an afterburner as a component.

7. The high temperature fuel cell system according to claim 1 with a reformer as a component.

8. The high temperature fuel cell system according to claim 1 with a heat exchanger, especially a plate heat exchanger as the component.

9. The high temperature fuel cell system according to claim 1 with a heat exchanger and a reformer as components.

10. The high temperature fuel cell system according to claim 1 with a heat exchanger and an afterburner as components.

11. The high temperature fuel cell system according to claim 1 with an afterburner and reformer as components.

12. The high temperature fuel cell system according to claim 5 with a heat exchanger, a reformer and an afterburner as components.

13. A method of operating a high temperature fuel cell stack with an afterburner according to claim 1 in which nonreacted fuel gas from the anode compartment of the fuel cell stack is burned together with air in the afterburner.

14. A method of operating a high temperature fuel cell stack with a heat exchanger according to claim 1 which the fresh fuel gas before being admitted into the anode compartment of the fuel cell stack is conducted through the heat exchanger.

15. The method of operating a high temperature fuel cell stack with a heat exchanger according to claim 1 in which the oxidation gas before being admitted into the cathode compartments of the fuel cell stack is conducted through the heat exchanger.

16. The method according to claim 13 wherein the unreacted fuel gas form the anode compartments of the fuel cell stack is burned together with air (cathode waste gas and if necessary fresh air) in the afterburner and the fuel gas before being admitted to the anode compartments of the fuel cell stack is passed through the prereformer such that a heat transfer from the fuel gas which is afterburned is applied to fresh fuel gas and contributes to a reformation.

17. The method according to claim 13 in which the nonreacted fuel gas from the anode compartments of the fuel cell stack (together with air) cathode waste gas and if necessary fresh air) is burned in the afterburner and the oxidation gas before being admitted to the cathode compartments of the fuel cell stack is passed through the heat exchanger so that a heat exchanger from the afterburned fuel gas to the oxidation gas is effected.

18. The method according to claim 13 in which the nonreacted fuel gas from the anode compartments of the fuel cell stack is burned together with air (cathode waste gas and if necessary fresh air) in the afterburner, and the oxidation gas before being admitted into the cathode compartments of the fuel cell stack is conducted through the heat exchanger so that a heat exchange is effected from the afterburned fuel gas to the oxidation as and the heating of the prereformer is effected by a partial flow of the afterburned fuel gas emerging from the afterburner.
